(19) United States
(12) Patent Application Publication
(10) Pub. No.: US 2012/0326544 A1
(43) Pub. Date: Dec. 27, 2012

(54) Magnetic break system

(76) Inventor: Shuen-Ri Jou, (US)

(21) Appl. No.: 13/169,838

(22) Filed: Jun. 27, 2011

(51) Int. Cl. H02K 49/02; H02P 15/00

(52) U.S. Cl. 310/93

(57) ABSTRACT

A magnetic brake system includes a magnetic induction unit, which is fixedly mounted at the chassis of a vehicle and comprising a stack of silicon steel sheets and a coil wound round the stack of silicon steel sheets and electrically connected to a switch at a brake pedal of the vehicle, and a magnetic attraction unit, which is arranged corresponding to the magnetic induction unit for causing a magnetic attractive or repulsive force between the magnetic induction unit and the magnetic attraction unit when the brake pedal is pressed to switch on the switch.

### BACKGROUND OF THE INVENTION

1. Field of the Invention

The present invention relates to a vehicle brake system and more particularly, to a magnetic brake system for vehicle, which stops the vehicle or reduces the speed of the vehicle by means of a magnetic attractive or repulsive force, avoiding friction damage.

2. Description of the Related Art

Regular vehicles may use a disk or drum brake system for stopping the wheels, or reducing the speed of the wheels. A vehicle brake system generally comprises a brake shoe or lining for friction against the associating wheel when the brake pedal of the vehicle is pressed. Because the brake shoe or lining wears quickly with use, it must be replaced with a new one a predetermined time after use. A damaged brake shoe or lining cannot perform well. An accident may occur when using a damaged brake shoe or lining to stop the wheel.

### SUMMARY OF THE INVENTION

The present invention has been accomplished under the circumstances in view. It is one object of the present invention to provide a magnetic brake system, which stops the vehicle or reduces the speed of the vehicle by means of a magnetic attractive or repulsive force, avoiding friction damage of component parts.

To achieve this and other objects of the present invention, a magnetic brake system comprises a magnetic induction unit and a magnetic attraction unit. The magnetic induction unit is fixedly mounted at the chassis of a vehicle, comprising a stack of silicon steel sheets and a coil formed of an enabled wire and wound round the stack of silicon steel sheets and electrically connected to a switch at a brake pedal of the vehicle. The magnetic attraction unit is arranged corresponding to the magnetic induction unit for causing a magnetic attractive or repulsive force between the magnetic induction unit and the magnetic attraction unit when the brake pedal is pressed to switch on the switch.

Further, the magnetic brake system can he a disc brake system. In this case, the magnetic attraction unit is made comprising a coil disposed opposite to the coil of the associating magnetic induction unit.

Further, the magnetic brake system can be a drum brake system. In this case, the magnetic attraction unit is made comprising magnetic attraction unit is surrounded by said magnetic induction unit so that magnetic brake system works as a drum brake.

### BRIEF DESCRIPTION OF THE DRAWINGS

FIG. 1 is a perspective view of a magnetic brake system in accordance with a first embodiment of the present invention.

FIG. 2 is a sectional view of the magnetic brake system in accordance with the first embodiment of the present invention.

FIG. 3 is a schematic drawing illustrating the arrangement of the circuit loop of the magnetic brake system in accordance with the first embodiment of the present invention.

FIG. 4 is a perspective view of a magnetic brake system in accordance with a second embodiment of the present invention.

FIG. 5 is a sectional view of the magnetic brake system in accordance with the second embodiment of the present invention.

FIG. 6 is an exploded view of a magnetic brake system in accordance with a third embodiment of the present invention.

FIG. 7 is a sectional view or the magnetic brake system in accordance with the third embodiment of the present invention.

FIG. 8 is a schematic drawing illustrating the arrangement of the circuit loop of the magnetic brake system in accordance with the third embodiment of the present invention.

FIG. 9 is an exploded view of a magnetic brake system in accordance with a fourth embodiment of the present invention.

FIG. 10 is a sectional view of the magnetic brake system in accordance with the fourth embodiment of the present invention.

### DETAILED DESCRIPTION OF THE PREFERRED EMBODIMENT

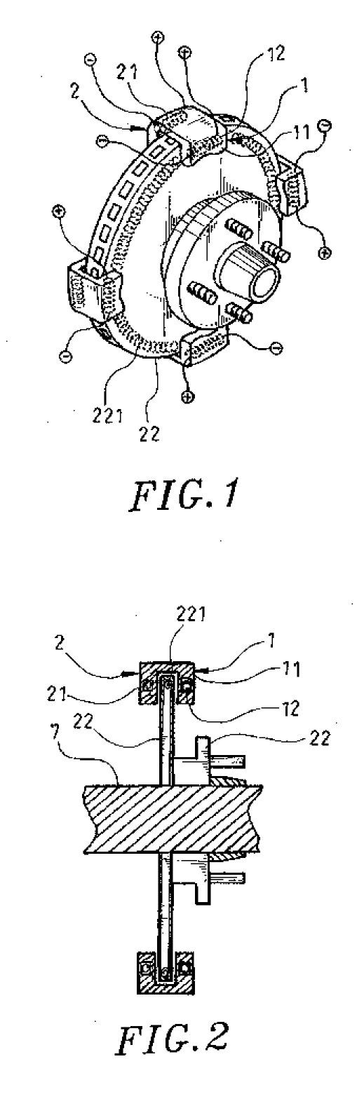

Referring to FIG. 1, a magnetic brake system in accordance with a first embodiment of the present invention is shown comprising a brake disc 22 carrying therein a coil 221, a plurality of magnetic induction units 1 fixedly mounted at the chassis of a vehicle and kept in proximity to one side of the brake disc 22, and a plurality of magnetic attraction units 2 respectively arranged in proximity to the opposite side of the brake disc 22 corresponding to the magnetic induction units 1. Further, each magnetic induction unit 1 and the associating magnetic attraction unit 2 are configured into a substantially inverted U-shape around the periphery of the brake disc 22. Further, each magnetic induction unit 1 comprises a stack of silicon steel sheets 11, and a coil 12 formed of an enabled wire and wound round the stack of silicon steel sheets 11. Each magnetic attraction unit 2 comprises a coil 21.

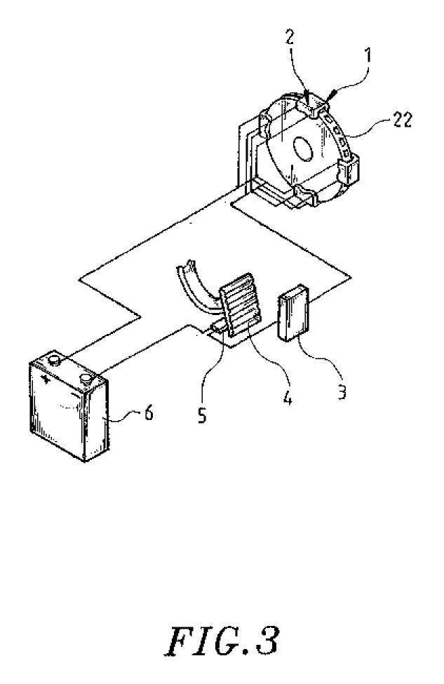

Referring to FIGS. 2 and 3, the coils 12 of the magnetic induction units 1 are electrically connected to a microcomputer control module 3, which is electrically connected to a switch 5 at the vehicle's brake pedal 4 of and then electrically connected to the vehicle's battery 6, The brake disc 22 is coupled to the vehicle's transmission system 7. When the driver steps on the brake pedal 4, the switch 5 is switched on to conduct the magnetic induction units 1 and the magnetic attraction units 2, causing a magnetic repulsive force to be produced between the magnetic induction units 1 and the magnetic attraction units 2, and therefore the brake disk 22 is stopped. Subject to the control or the microcomputer control module 3, the intensity of the magnetic field between the magnetic induction units 1 and the magnetic attraction units 2 is controlled, i.e., the desired magnetic repulsive force is produced to stop the vehicle or to reduce the speed of the vehicle. Because no friction is produced between parts of the brake system when stopping the vehicle, the invention avoids wearing damage of component parts of the brake system.

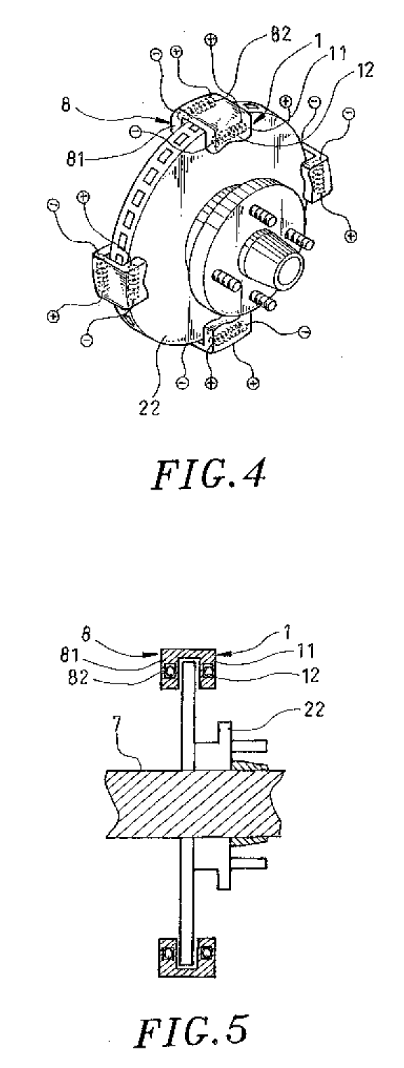

FIG. 4 is a perspective view or a magnetic brake system in accordance with a second embodiment of the present invention. According to this second embodiment, the magnetic brake system comprises a brake disc 22, a plurality of magnetic induction units 1 fixedly mounted at the chassis of a vehicle and kept in proximity to one side of the brake disc 22, and a plurality of magnetic conduction units 8 respectively arranged in proximity to the opposite side of the brake disc 22 corresponding to the magnetic induction units 1. Further, each magnetic induction unit 1 and the associating magnetic attraction unit 2 are configured into a substantially inverted U-shape around the periphery of the brake disc 22. Further, each magnetic induction unit 1 comprises a stack of silicon steel sheets 11, and a coil 12 formed of an enabled wire and wound round the stack of silicon steel sheets 11. Each magnetic conduction unit 8 comprises a stack of silicon steel sheets 81, and a coil 82 formed of an enabled wire and wound round the stack of silicon steel sheets 81.

Referring to FIG. 5, the coils 12 of the magnetic induction units 1 are electrically connected to a microcomputer control module 3, which is electrically connected to a switch 5 at the vehicle's brake pedal 4 of and then electrically connected to the vehicle's battery 6 (see also FIG. 3). The brake disc 22 is coupled to the vehicle's transmission system 7. When the driver steps on the brake pedal 4, the switch 5 is switched on to conduct the magnetic induction units 1 and the magnetic conduction units 8, causing a magnetic attractive force to be produced between the magnetic induction units 1 and the magnetic conduction units 8, and therefore the brake disk 22 is stopped. Subject to the control of the microcomputer control module 3, the desired magnetic attractive force is produced to stop the vehicle or to reduce the speed of the vehicle. Because no friction is produced between parts of the brake system when stopping the vehicle, the invention avoids wearing damage of component parts of the brake system.

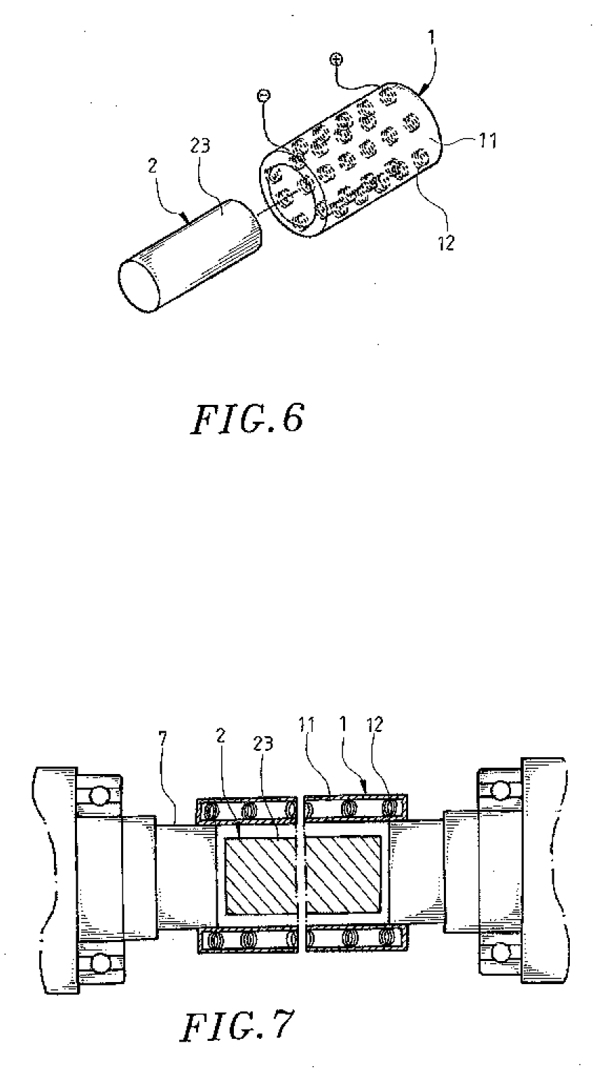

Referring to FIG. 6, a magnetic brake system in accordance with a third embodiment of the present invention is shown comprising a magnetic induction unit 1 fixedly mounted at the chassis of a vehicle and a magnetic attraction unit 2 surrounded by the magnetic induction unit 1. The magnetic induction unit 1 comprises a stack of silicon steel sheets 11 of a tubular configuration, and coils 12 mounted in the stack of silicon steel sheets 11. The magnetic attraction unit 2 is formed of a ferrite tube 21 and surrounded by the magnetic induction unit 1.

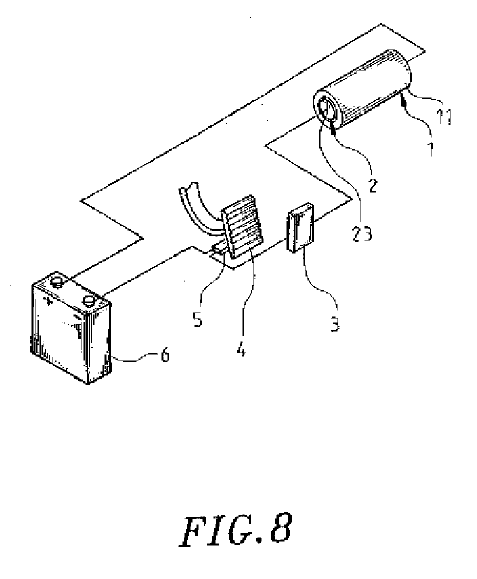

Referring to FIGS. 7 and 8, the magnetic induction unit 1 is coupled to the battery 5 (see also FIG. 3). The brake disc 22 is coupled to the vehicle's transmission system 7; the coils 12 of the magnetic induction unit 1 are electrically connected to a microcomputer control module 3, which is electrically connected to a switch 5 at the vehicle's brake pedal 4 of and then electrically connected to the vehicle's battery 6. When the driver steps on the brake pedal 4, the switch 5 is switched on to conduct the magnetic induction unit 1, causing a magnetic attractive force to be produced between the magnetic induction unit 1 and the magnetic attraction unit 2. Subject to the control of the microcomputer control module 3, the desired magnetic attractive force is produced to stop the vehicle or to reduce the speed of the vehicle. Because no friction is produced between parts of the brake system when stopping the vehicle, the invention avoids wearing damage of component parts of the brake system.

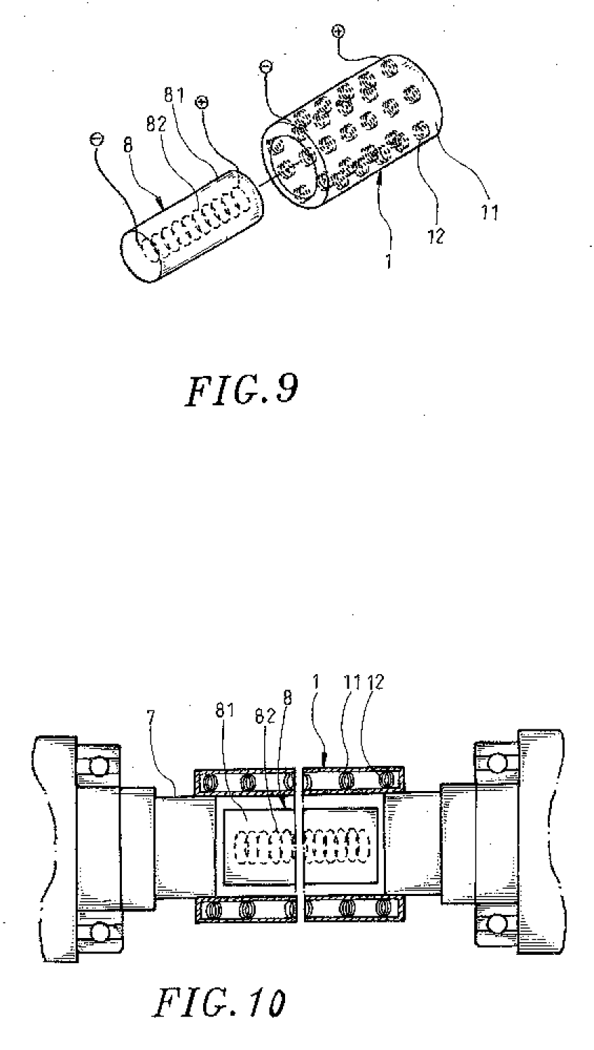

Referring to FIG. 9, a magnetic brake system in accordance with a fourth embodiment of the present invention is shown comprising a magnetic induction unit 1 fixedly mounted at the chassis of a vehicle and a magnetic conduction unit 8 surrounded by the magnetic induction unit 1. The magnetic induction unit 1 comprises a stack of silicon steel sheets 11 of a tubular configuration, and coils 12 mounted in the stack or silicon steel sheets 11. The magnetic conduction unit 8 comprises a tubular silicon steel sheets 81 surrounded by the stack of silicon steel sheets 11 of the magnetic induction unit 1, and a coil 82 mounted in the tubular silicon steel sheets 81.

Referring to FIG. 10, the coils 12 of the magnetic induction unit 1 and the coil 82 of the magnetic conduction unit 8 are electrically connected to a microcomputer control module 3, which is electrically connected to a switch 5 at the vehicle's brake pedal 4 of and then electrically connected to the vehicle's battery 6 (see also FIG. 8). The magnetic induction unit 1 is coupled to the vehicle's transmission system 7. When the driver steps on the brake pedal 4, the switch 5 is switched on to conduct the magnetic induction units 1 and the magnetic conduction units 8, causing a magnetic repulsive force to be produced between the magnetic induction units 1 and the magnetic conduction units 8. Subject to the control of the microcomputer control module 3, the desired magnetic repulsive force is produced to stop the vehicle or to reduce the speed of the vehicle. Because no friction is produced between parts of the brake system when stopping the vehicle, the invention avoids wearing damage of component parts of the brake system.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A magnetic brake system, comprising:
a magnetic induction unit fixedly mounted at the chassis of a vehicle, said magnetic induction unit comprising a stack of silicon steel sheets and a coil formed of an enabled wire and wound round the stack of silicon steel sheets and electrically connected to a switch at a brake pedal of the vehicle; and
a magnetic attraction unit arranged corresponding to said magnetic induction unit for causing a magnetic attractive or repulsive force between said magnetic induction unit and said magnetic attraction unit when said brake pedal is pressed to switch on said switch.

2. The magnetic brake system as claimed in claim 1, wherein said magnetic attraction unit comprises a coil disposed opposite to the coil of the associating magnetic induction unit so that the magnetic brake system works as a disc brake.

3. The magnetic brake system as claimed in claim 1, wherein said magnetic attraction unit is surrounded by said magnetic induction unit so that magnetic brake system works as a drum brake.

4. The magnetic brake system as claimed in claim 1, wherein said magnetic induction unit is electrically connected to a microcomputer control module that controls the intensity of the magnetic field produced between said magnetic induction unit and said magnetic attraction unit so as to stop the vehicle or to reduce the speed of the vehicle.

5. A magnetic brake system, comprising:
a magnetic induction unit fixedly mounted at the chassis of a vehicle, said magnetic induction unit comprising a stack of silicon steel sheets and a coil formed of an enabled wire and wound round the stack of silicon steel sheets; and
a magnetic conduction unit arranged corresponding to said magnetic induction unit, said magnetic conduction unit comprising a stack of silicon steel sheets and a coil formed of an enabled wire and wound round the stack of silicon steel sheets;
wherein the coil of said magnetic induction unit and the coil of said magnetic conduction unit are respectively electrically connected to positive and negative terminals of a battery through a switch at a brake pedal of the vehicle for causing a magnetic repulsive force between said magnetic induction unit and said magnetic attraction unit when said brake pedal is pressed to switch on said switch.

6. The magnetic brake system as claimed in claim 5, wherein said magnetic induction unit and said magnetic attraction unit are respectively arranged at two opposite sides relative to a brake disc.

7. The magnetic brake. system as claimed in claim 5, wherein said magnetic induction unit and said magnetic attraction unit are electrically connected to a microcomputer control module, which controls the intensity of the magnetic fields produced between magnetic induction unit and said magnetic attraction unit.
